(19) United States
(12) Patent Application Publication
(10) Pub. No.: US 2005/0091144 A1
(43) Pub. Date: Apr. 28, 2005

(54) Buyer's offer auctions for goods & services, rights or properties

(76) Inventors: Robert Longman, Chicago, IL (US); Sophia C. Li, Chicago, IL (US)

Correspondence Address: ROBERT LONGMAN;;SOPHIA C. LI, UNIT 145, 1749 GOLF ROAD, MOUNT PROSPECT, IL, 60056, US

(21) Appl. No.: 10/696,441

(22) Filed: Oct. 28, 2003

(51) Int. Cl. G06F 17/60

(52) U.S. Cl. 705/37

(57) ABSTRACT

The present invention provides a method and system for conducting a sealed offer online auction. For every bidder, he/she will send in only one offer to the online system on the item he/she is bidding on. Their offers are kept sealed from other bidders, but are open to only the seller of the item. These offers are arranged in an order not by price, but according to the time when the offers are placed. The seller can end the auction anytime up to the auction deadline by accepting an offer from one of the bidders. The accepted offer need not be the highest offer at the time; however, it is reasonable to assume that the seller will accept the highest offer at the time. In the case of same highest offer made by more than one bidder, the seller can choose any one of those highest offer at the seller's discretion prior to the auction deadline. The seller can also decline an offer from any bidder based on the bidder's feedback history listed with the online auction system provider prior to the auction deadline. Only during the period before the auction ends can the seller disqualifies an offer from a bidder by using the method of declining an offer. If the seller chooses not to end the auction prior to the scheduled auction deadline, the winner of the auction will be the bidder who place the highest bid on the item at the auction deadline, and the seller is obligated to accept this highest offer regardless seller's preference. In the case of same highest offer made by more than one bidder, the winner will be the bidder who first places the highest offer according to the online auction system time tracker. Bidders can also retract his/her offer prior to the auction closing. Once an offer is retracted, the bidder who retracts the offer will be automatically disqualified for placing any future offer on the item. However, once the seller accepts an offer, the auction ends and no offers can be retracted.

### REFERENCES CITED

1. “Finding Sustainable Profitability in the E-commerce Continuum” by John M de Figueiredo; http://ebusiness.mit.edu/Paper129 (April 2000).
2. “Game Theory and Competition” by R. Preston McAfee and John McMillan; University of Texas/Working Paper (1998).
3. “A Study of Moderators of the Herding Bias in Digital Auctions” by Paul Dholakia, Suman Basuroy, and Kerry Soltysinski; International Journal of Research in Marketing (2002).
4. “Prices and the Winner's Curse” by Jeremy Bulow, Ming Huang, and Paul Klemperer; Stanford University/Working Paper (1998).
5. “Last Minute Bidding and the Rules for Ending Second-Price Auction: Theory and Evidence from a Natural Experiment on the Internet” by Alvin E. Roth and Axel Ockenfels; National Bureau of Economic Research/Working Paper (June 2000).
6. “Public Versus Secret Reserve Prices in eBay Auctions” By David Lucking-Reiley and Rama Katkar; National Bureau of Economic Research/Working Paper (March 2001).

### FIELD OF INVENTION

The invention relates to auctions and more particularly to online auctions for goods and services.

### BACKGROUD

The rise of online auctions has provided personal and small retail sellers a cost effective way to market their goods and services while simultaneously generates plenty of potential buyers to compete against each other in seeking to deliver the best market price at any time for the sellers.

There are various methods of online auctions: “no reserve” auction where the winner is the highest bidder at the auction deadline; “reserve” auction where the seller will set a minimum price for the item, and the winner is the highest bidder who meets the reserve amount at the auction deadline; “buy it now” auction where the seller will set an offer for the item, and the winner is the one who first views the auction and accepts the offer set by the seller. Although all these auction methods are quite popular, they are flawed in their own approaches.

“No reserve” auction is an open auction and is supposedly to reveal the true market price of an item; however, it often leads to under-pricing of an item since every bidder wants to pay less and causes bidders to place bids less than their perceived value of an item. Concurrently, open auction means highest bid on an item at any time is revealed to other potential bidders. It is often the case that bidders place bids higher than the item's true value for the purpose of winning the auction, a scenario called “the winner's curse”.

According to de Figueiredo, “The utility buyers obtain from auctions may not be from the goods purchased, but from the satisfaction of the ‘game’ of the auction and ‘winning’ the auction”. Despite many bidders are rational in their offer, some maybe easily trapped in so called “the winner's curse”—the winner is likely to be the bidder who has most overestimated the item's value.

“Reserve” auction protects a seller's basic investment on an item but is frequently used in an abusive manner by the seller to inflate the actual value of an item. Bidders are regularly caught in a vicious cycle of placing bids after bids in order to meet the reserve price. The reserve amount only reflects the price the seller dictates instead of revealing the true market value of an item.

In Public vs. Secret reserve prices in eBay auctions, Katkar and Lucking-Reiley try to find out whether the seller is made better or worse off by setting a secret reserve above a low minimum bid, versus the option of making the reserve public by using it as the minimum bid level. The researchers auctioned 50 matched set items, half with secret reserves and half with equivalently high public minimum bids. They found that “reserve prices make us worse off as sellers, by reducing the probability of the auction resulting in a sale, deterring serious bidders from entering the auction, and lowering the expected transaction price for the auction”. They also found that some sellers choose to use secret reserve prices other than securing their minimum profits. In a poll conducted by the researchers for items that did not result in a sale because the reserve price was not met, they found 80% sellers emailed the highest bidder after the auctions closed and asked them if they would be interested to take the item at their highest bids. In essence, sellers are using reserve price to confuse bidder what the true value of the item is.

“Buy it now” auction allows sellers to gain instant liquidity at prices satisfactory to the sellers, yet its shortcomings are fairly obvious. If the seller sets the price too high, then the item will not be sold. Conversely, if the seller sets the price too low due to lack of knowledge on the item he/she is selling, the item will usually be sold at far below market value to the bidder who first saw the item and has the knowledge about the true value of the item.

Buy it now auction creates a first mover advantage for potential buyers, and in many cases allow them to purchase items at a below fair market value price. Once a bid is place, the buy it now option disappears. However, such function also adds pressure to a buyer to act irrationally for the purpose of winning rather than act according to the fair value of the items. Buy it now option often used by sellers for various reasons. First, the option incurs no extra costs for the possibility of immediate liquidity. Second, the option allows seller to post a price that could be taken by bidders as fair market value. For instance, an item with a fair market value of $49 has an open minimum bid of $49.00 and an option to buy it now for $249. In such case, bidders will bid on the minimum price level but with an impression that the item is worth $249. As more bidders enter the same auction, bidders will place higher bids as long as the bids do not exceed $249.

Of course, there are other less popular online auction methods such as the “name your price”. auction that has been adopted by Priceline.com. “Name your price” auction is a method where potential buyers will enter prices for the items they are interested in. If the buyer's price meets the seller's asking price, a sale is made. If the buyer's price is less than the seller's asking price, then no sale is conducted. Thus, the buyer can either enter a higher price and continue to do so until the seller's asking price is met, or the buyer can exit the bidding on that item. Such auction method is no more practical or purposeful than the “reserve” auction.

In addition, there are various psychological phenomenon associated with the process of bidding online, which cause inefficiency in auction pricing. The three most noticeable phenomenons are the “heard mentality”, the “sunk cost effect”, and the “last minute bidding”.

According to a study conducted by Paul Dholahia, herd mentality is described as “the tendency to gravitate toward, and bid for, auction listings with one or more existing bids, while ignoring comparable or even more attractive unbid-for listings available at the same time”. Although the study offers no information on why a listing attracts the initial bids that give it the momentum to become coveted, Dholahia speculates “With hundreds of thousands of listings and so many different choices, people need a method of simplifying the process. The simplifying rule that people use to decide which item they want to consider is to follow the herd behavior”. This could be one explanation to the phenomena, but perhaps the herd instinct is just another reflection of competitive mechanism. Bidder's psychology of winning the game is more satisfactory than the items alone; so items received no bids automatically being disqualified as noncompetitive game, and thus discourage bids. Sellers, who are aware of such phenomenon, thus are motivated to place shill bidding in order to attract more bidders to their listings.

Some bidders fall into the trap of a behavior known as the “sunk cost effect” in cognitive psychology. Research shows that individuals manifest a greater tendency to continue an endeavor once an investment in money, time, or effort has been made.

The late bidding behavior that causes inefficient pricing in auctions is called last minute bidding. According to eBay, 18% of auctions has bids in the last sixty seconds. In a study involving 368 eBay buyers and conducted by Roth and Ockenfel, they found experienced buyers tend to use last minute bidding more than inexperienced buyers. 91% of the bidder confirms that late bidding is part of their early planning bidding strategy; 65% express such strategy is to avoid a “bidding war” or to keep the price down. 10% states that late bidding enables them to avoid sharing valuable information with other bidders through price levels.

Although structuring a flawless auction method is practically impossible, the present invention provides a superior archetype for conducting online auctions. “Buyer's offer” auction utilizes buyers' knowledge about the item while avoiding all three psychological phenomenons associated with online bidding. In a “Buyer's offer” auction, potential bidders will have plenty time to consider their offers and submit only once during the course of the auction. This technique will reduce the amount of reckless game bidding and encourage serious potential bidders to submit prices that are considered the best in their judgments. Since all offers are sealed from other bidders and sorted by entry time, bidders are not informed of others' knowledge about the item nor can they be sure if there are other bidders who also acquire the same knowledge about the item, thus bidders are inclined to place the best offer in their minds in order to have their offers accepted as the winning offer. On the other hand, “Buyer's offer” auction still preserves the benefit of instant liquidity for sellers as sellers have the option to end the auction any time by accepting an offer. Furthermore, the option of instant liquidity is now in the hands of the sellers rather than in the hands of the bidders in the case of “Buy it now” auction.

### SUMMARY OF THE INVENTION

The present invention provides a superior archetype for conducting online auctions. For every bidder, he/she will send in only one offer to the online system on the item he/she is bidding on. Their offers are kept sealed from other bidders, but are open to only the seller of the item. These offers are arranged in an order not by price, but according to the time when the offers are placed. The seller can end the auction anytime up to the auction deadline by accepting an offer from one of the bidders. The accepted offer need not be the highest offer at the time; however, it is reasonable to assume that the seller will accept the highest offer at the time. In the case of same highest offer made by more than one bidder, the seller can choose any one of those highest offer at the seller's discretion prior to the auction deadline. The seller can also decline an offer from any bidder based on the bidder's feedback history listed with the online auction system provider prior to the auction deadline. Only during the period before the auction ends can the seller disqualifies an offer from a bidder by using the method of declining an offer. If the seller chooses not to end the auction prior to the scheduled auction deadline, the winner of the auction will be the bidder who place the highest bid on the item at the auction deadline, and the seller is obligated to accept this highest offer regardless seller's preference. In the case of same highest offer made by more than one bidder, the winner will be the bidder who first places the highest offer according to the online auction system time tracker. Bidders can also retract his/her offer prior to the auction closing. Once an offer is retracted, the bidder who retracts the offer will be automatically disqualified for placing any future offer on the item. However, once the seller accepts an offer, the auction ends and no offers can be retracted.

### BREIF DESCRIPTION OF THE DRAWINGS

FIG. 1 is an overall diagram of the system.

FIG. 2 illustrates the elements on a web page for conducting a Buyer's Offer auction.

FIG. 3 is a high level flow diagram of the various operations that take place on a seller's end.

FIG. 4 is a high level flow diagram of the various operations that take place on bidders' end.

FIG. 5 is a program flow diagram of a seller declining an offer.

FIG. 6 is a program flow diagram of a seller accepting an offer.

FIG. 7 is a program flow diagram of a bidder making and retracting an offer.

### DESCRIPTION OF PREFERRED EMBODIMENTS

As used herein the following terms have the meaning given below:

“Item”—means goods and services, rights or properties.

“Auction Duration”—means the period between the auction start date and scheduled end date.

“User ID”—means the identification a buyer or seller use during the auction process.

“Seller's Feedback”—means a list of comments made by previous users who have completed transaction with the seller.

“Buyer's Feedback”—means a list of comments made by previous users who have completed transaction with the buyer.

“Number of Offers”—means the total number of actual offers being placed on the item; it is not a counter for tracking potential buyers.

“Sealed Offer”—means an offer that is undisclosed to other buyers.

“Winning Offer”or “End Price”—means the price that wins the item at the end of an auction.

“Retracting Offer”—means a buyer withdraws an offer that has been made earlier.

“Time of Entry”—means the time when each offer is made.

“System Controller”—means a computer system or web server that performs various calculations and operations hereinafter described.

“System Operator”—means an individual, company, party, entrepreneur or other entity that operates or is responsible for the computer system or web server that performs various calculations and operations hereinafter described. This entity will act as the liaison between sellers and buyers for conducting an online Buyer's Offer auction.

“Potential Buyer”—means anyone within the system network who has learned of a buyer's offer auction, has shown interests in participating in the auction, and may participate in the auction during the course of the auction.

“Participating Buyer”—means anyone within the system network who has actually made a buyer's offer on the item being auctioned.

### DETAILED DESCRIPTION OF THE INVENTION

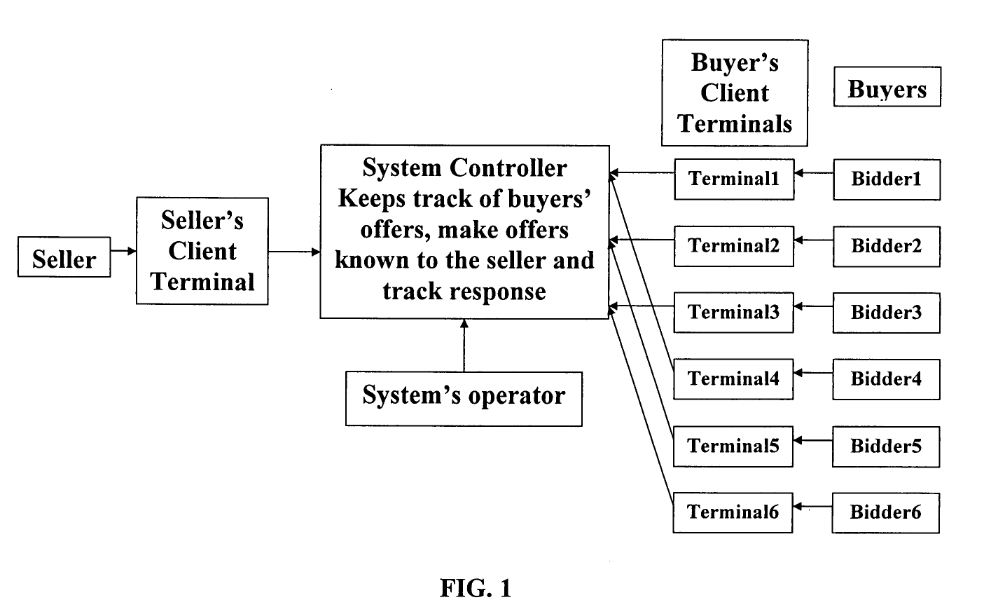

An overall diagram of the invention is shown in FIG. 1. For each buyer's offer auction, the system connects the single seller with plurality of buyers by means of a system controller. There can only be one seller for each listing auction; however, the actual numbers of buyers for each auction can be greater or less than six as long as there is at least one buyer to result in an auction purchase. The system controller can handle almost unrestricted amount of auction listings; at any time, there are plurality of sellers, plurality of buyers, and plurality of auctions within the system network.

The seller communicates with the controller via the seller's client terminal, and the buyers 1 to 6 communicate with the controller via buyer's client terminals 1 to 6. Communication is via the Internet. Both the seller and the buyers' terminals are connected to an ISP (Internet Service Provider) which provides access to the Internet. Correspondingly, controller is also connected to the Internet via an ISP. The drawing lines in FIG. 1 thus represent logical information flow and not physical connections. The seller and the buyers 1 to 6 are described as being online.

The seller's client terminal can be a variety of forms of terminals that are obtainable such as computers, laptops, WebTVs, PDAs, information appliances, or any other devices that can be used by the seller to access the system controller over a network, so the seller can specify description and terms of the item being auctioned, answer questions and requests from potential buyers, and accept or decline offers made by participating buyers.

The system controller is one or more network servers running software to keep track the seller's description and auction terms; “intelligently” manage appearance of the auction listing on one or more virtual media such as web sites; and correctly track or process offers made by buyers who seek to participate in the auction.

The system operator utilizes a client terminal to access and configure the system's controller as is conventional with computer systems and network servers.

The buyers' client terminal 1 to 6 are any of the various forms of terminals that are employed to access web sites such as computers, laptops, thin-client, WebTVs, two-way TV, PDAs, information appliances, or any other devices that buyers may utilize to learn auction listings presented by the controller, post questions or request regarding the auction listing, and be able to make and retract offers using buyers' client terminals.

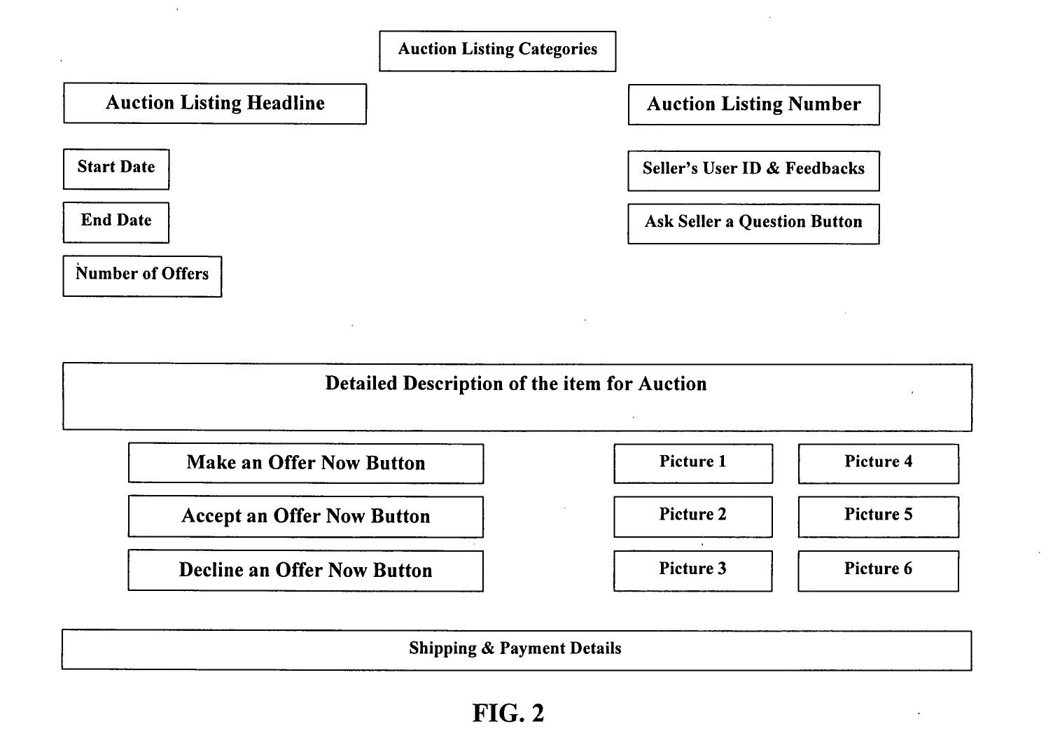

FIG. 2 is a diagram illustrating the elements on a web page which the controller presents to buyers 1 to 6. It is noted that FIG. 2 merely illustrates the fields that are relevant to a preferred embodiment of the invention. FIG. 2 is not meant to illustrate the actual layout of a web page. An actual web page would be laid out in a creative, artistic fashion so as to present a pleasing visual appearance. The artistic nature of the visual appearance of the web page is not relevant to the present invention.

a) A conventional “auction listing categories” is a brief reference of the nature of the item being auctioned. It is relevant to the system's categorization function, but such field is not required for the purpose of system operation.

b) A conventional “auction listing headline” may include a brief description of the item being auctioned. It is relevant to the system's search function which is commonly used by buyers, but such field is not actually essential to the operation of the system.

c) A conventional “auction listing number” is a series of computer generated numbers which is implemented by the system controller for identification purpose.

d) “Start date” and “end date” determines the auction duration.

e) “Number of offers” in general implies the attractiveness of an auction, and is practical for the seller, the buyers, and the system controller.

f) “Seller's user ID and Feedbacks” allows potential buyers to determine the worthiness of conducting a transaction with the seller.

g) “Ask seller a question button” is a shortcut for buyers to communicate with the seller regarding questions and requests relevant to the item being auctioned prior to making any offers.

h) “Detail description of the item” includes but no limited to both the quantitative and qualitative measurements relevant to the item being auctioned.

i) “Pictures 1 to 6” gives potential buyers any applicable visual illustration of the item being offered.

j) “Shipping and payment details” are the terms set by the seller and automatically accepted by participating buyers regarding matters after the auction ends.

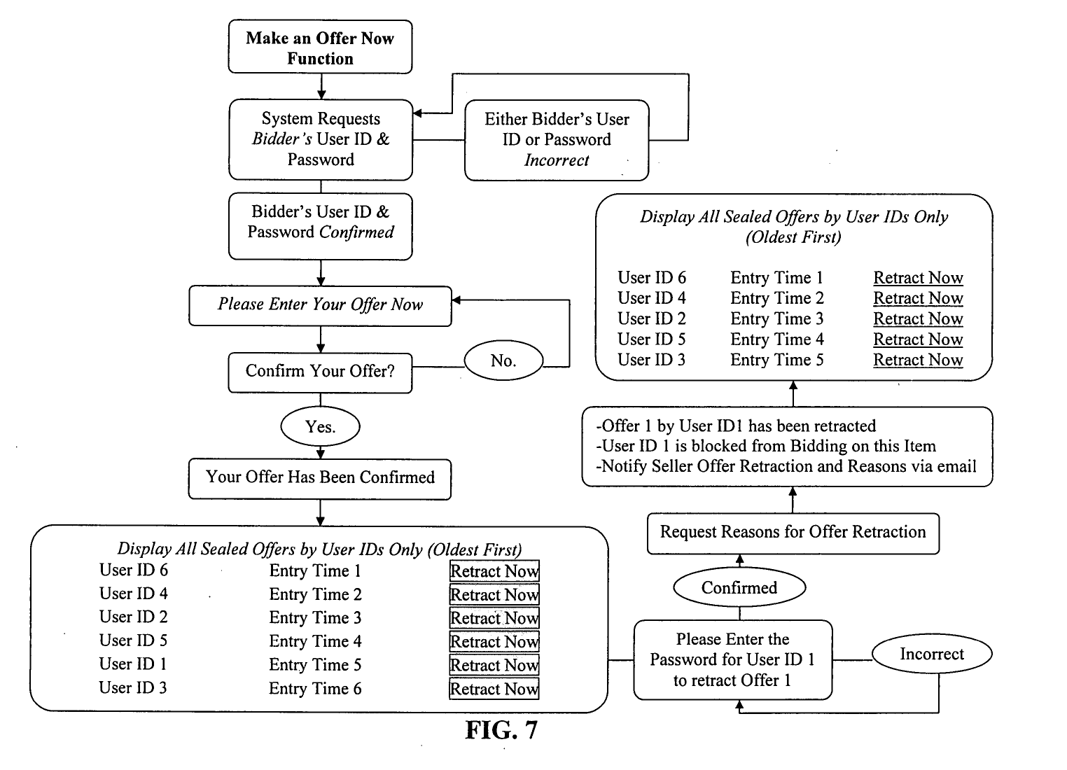

k) “Make an offer now button” is one of the three main functions of the said system. It is a function used by participating buyers to make buyers' offers on the item. Its detailed functionality and operational process will be discussed later relating to FIG. 7.

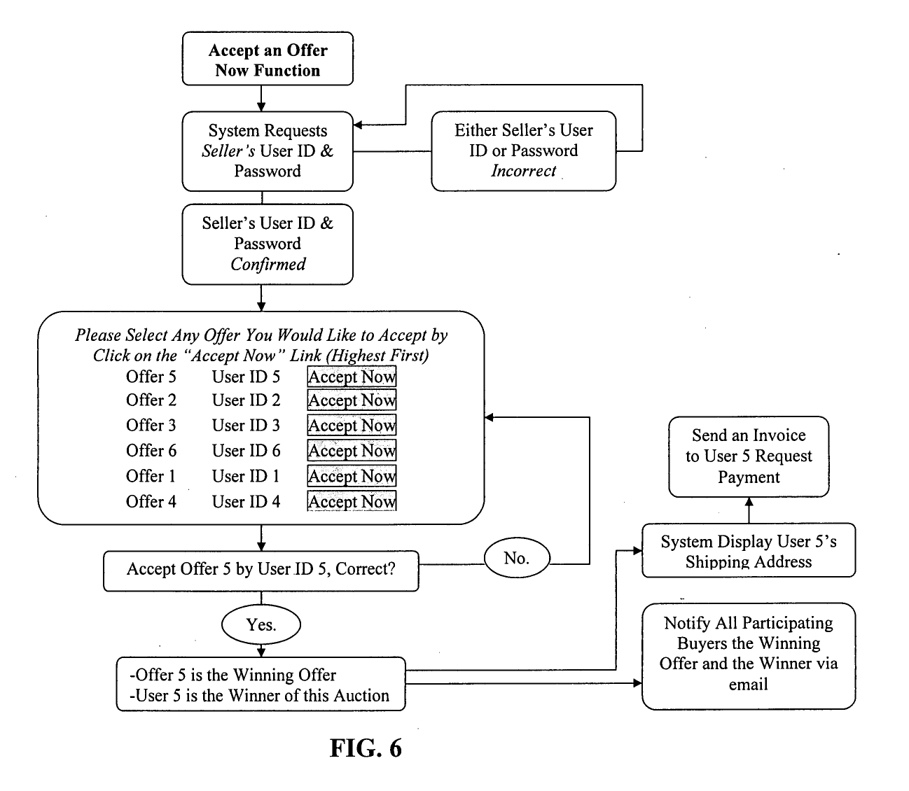

l) “Accept an offer now button” is the second main function of the said system. It is a function used by the seller to accept any offer placed by participating buyers and to end the auction prior to the auction deadline. Its detailed functionality and operational process will be discussed later relating to FIG. 6.

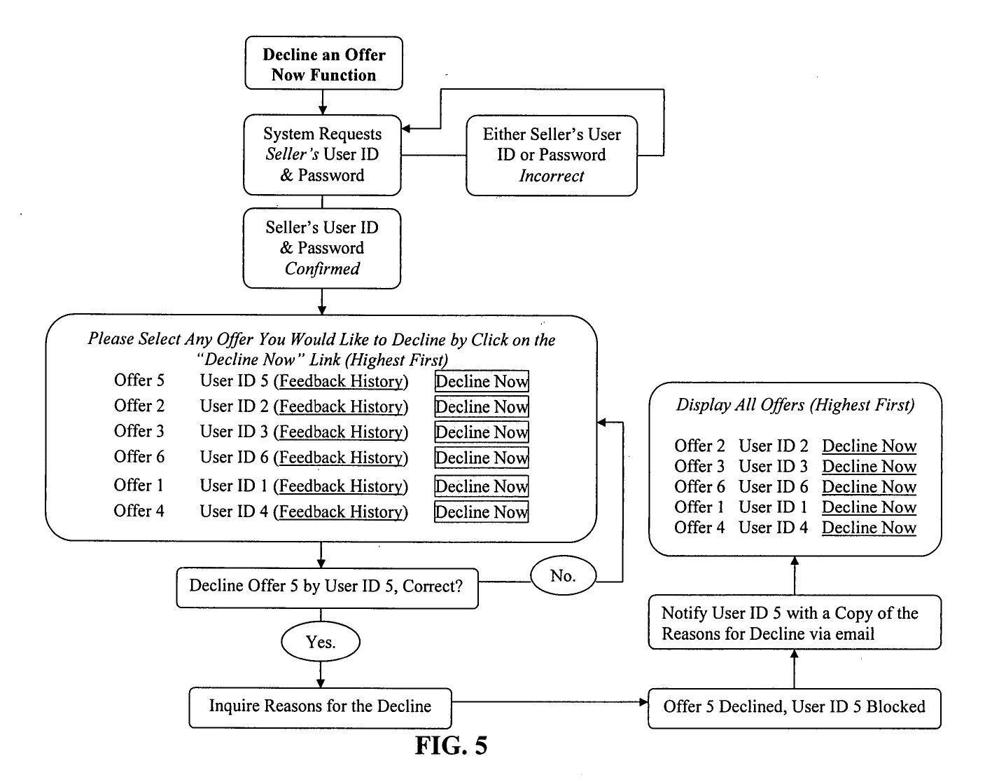

m) “Decline an offer now button” is the third main function of the said system. It is a function used by the seller to deny any offer placed and block any participating buyer during the auction. Its detailed functionality and operational process will be discussed later relating to FIG. 5.

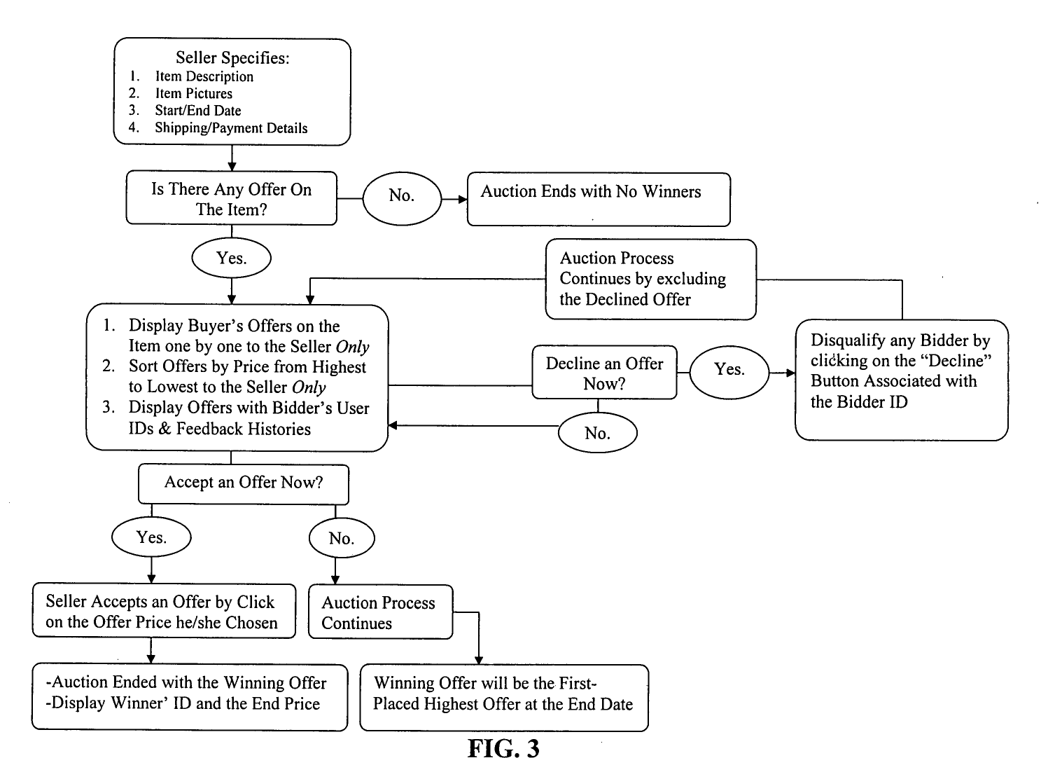

FIG. 3 is an overall diagram of the various operations that take place on a seller's end. The process begins when a seller creates an auction listing to sell a particular item by placing item description, item pictures, auction duration, and auction terms over the web page. For example, the seller wishes to sell a carved ivory cameo using a Buyer's Offer auction online. The seller will specify detailed description of the cameo such as its age, size, condition, and etc. The seller will post pictures of the item for visual account. The seller will specify the auction duration for 7 days.

Once the auction starts, the system will automatically tracking any offers placed on the item. If there is no offer on the item over the 7 day duration, then the auction will end with no winners. If there is at least one offer on the item, then the system will display to seller only a) all offers by bidders; b) sort these offers by price from highest to lowest; c) Bidder's user IDs and feedback histories.

The seller will be given two options—“accept an offer” or “decline an offer”.

If the seller chooses “yes” to “accept an offer”, the seller will end the auction by selecting any one of the offers placed on the item. Most probably, the seller will select the highest offer placed on the item although the seller is not obligated to choose the highest offer. The chosen offer will then become the winning offer on the item, and the user ID associated with the winning offer will be declared the winner of the auction. The auction duration in such scenario will be less than scheduled 7 days.

If the seller chooses “no” to “accept an offer”, the auction process will continue until 7 days has passed. The system will continue to track any more offers placed on the item during the 7 days. Upon the scheduled auction closing, the system controller will sort all offers from highest to lowest and compare time of entry for all offers. The system controller will locate the first-placed highest offer on the item and select that offer as the winning offer, and the system will establish the user ID associated with the winning offer as the winner of the auction.

If the seller chooses “yes” to “decline an offer”, the system controller will be notified instantly which offer has been declined by the seller, and it will disqualify the particular bidder by deleting the offer associated with the disqualified bidder from the auction. Auction process then continues as usual, excluding the disqualified offer.

If the seller chooses “no” to “decline an offer”, the system controller will not act at all.

Although sellers can accept only accept one offer in each Buyer's Offer auction, sellers are allowed to decline more than one offer in each Buyer's Offer auction if necessary. However, the seller will be required to deliver an explanation for each offer declined in such an auction, and the explanations will be recorded by the system controller.

It must be noted that both “accept an offer” and “decline an offer” options are only available to the seller prior to the scheduled auction closing. Once the auction is closed, only the system controller has the authority to access, declare, and record the winning offer and the winner in a Buyer's Offer auction.

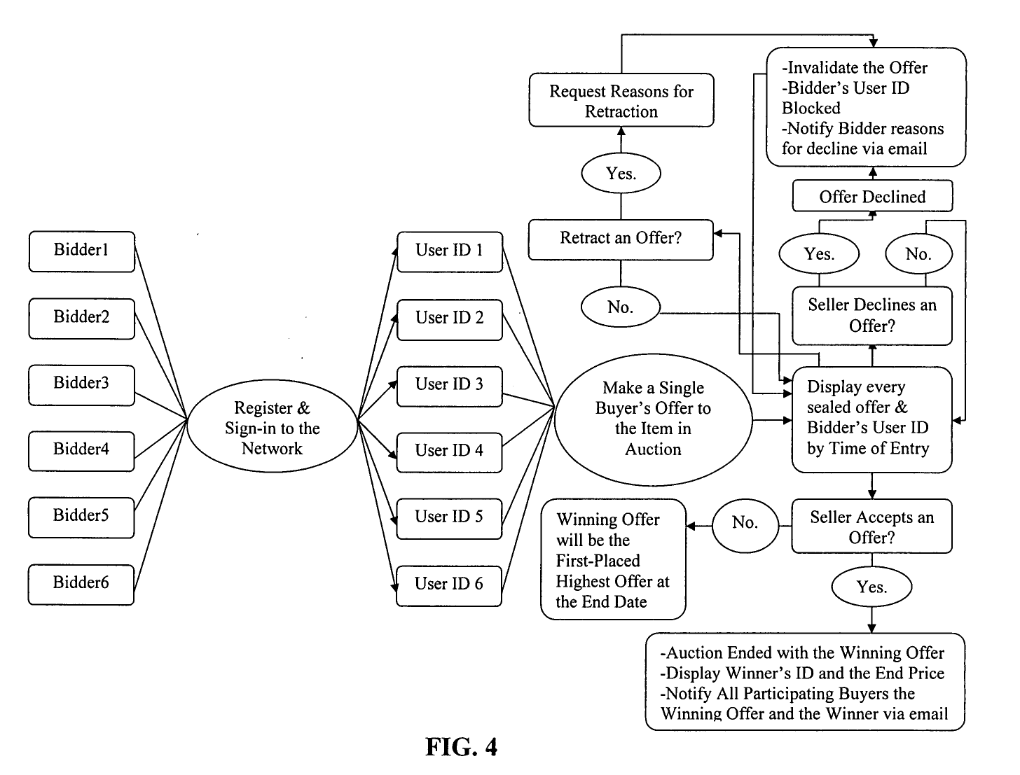

FIG. 4 is an overall diagram of the various operations that take place on bidders end. The process starts with bidders register and sign-in to the online network where the system controller is located. Once their logins are accepted by the system controller, bidders are only identified by their User IDs and feedback histories within such online network. Bidder 1 to 6 are now identified as User 1 to 6, and these six users all are interested in the Buyer's Offer auction posted by the seller in FIG. 3 example. Each of them then placed a single offer on the carved ivory cameo. Now User 6 are the participating buyers on the carved ivory cameo.

Any User within the network is now able to view the web page presented by the system controller that contains a list of bidders on the carved ivory cameo. Such list will contain sealed offers identified only by User IDs, and these sealed offers are sorted only by the time of entry.

User 1 to 6 are given the option to “retract an offer” any time prior to the auction end. If any one of them chooses “yes” to “retract an offer”, such user's offer will be retracted and treated as invalid. Such user will then automatically be blocked from entering same auction by the system controller. If no offer retraction is made by any participating buyer, then the auction continues as usual.

If the seller chooses to decline any offer, any disqualified user will be notified by the system controller of such action along with seller's explanation. If the seller chooses to accept any offer, all participating users will be notified by the system controller of the winning offer and the winner of the auction. If the seller chooses not to accept any offer prior to the auction closing, then all participating buyers will be notified by the system controller of the winning offer and winner determined by the system controller at the auction end date.

FIG. 5 is a detail diagram of the operational process of the “decline an offer” function granted to a seller in a Buyer's Offer auction. The process begins when a seller chooses the “decline an offer now” function on the auction listing web page. For instance, the seller in the example of “carved ivory cameo” clicks on the “decline an offer now” link in FIG. 2 where carved ivory cameo is listed.

For security purpose, the system controller will request the particular seller to enter the seller's User ID and password with the online network. If the seller's User ID or password does not match the record maintained by the system controller, access to declining an offer function will be denied. The system controller will re-request the seller's User ID and password until both match the record maintained by the system controller. It is optional for the system controller to set a maximum trial time for such request for advanced site security.

If the seller's User ID and password match the record maintained by the system controller, a list of all offers placed on the carved ivory cameo will be displayed to the seller. The list will be sorted by price from the highest to the lowest. The list will contain each offer, each User ID and its associated feedback history. There will also be a decline now function linked with each offer placed on the item. For illustration:

| | | |
|---|---|---|
| $255 | User 5 (Feedback History) | Decline Now |
| $235 | User 2 (Feedback History) | Decline Now |
| $177 | User 3 (Feedback History) | Decline Now |
| $146 | User 6 (Feedback History) | Decline Now |
| $132 | User 1 (Feedback History) | Decline Now |
| $88 | User 4 (Feedback History) | Decline Now |

As in the example, User 5 has the highest offer on the carved ivory cameo for $255. If there is no new offer on the item, and the seller chooses not to accept any offer prior to the scheduled auction end date, then User 5 will be the winner of this auction with the winning offer at $255, which the seller will be obligated to accept at the auction closing.

However, suppose the seller finds out that User 5 has plenty of negative feedbacks on its feedback history, and the seller decides rather not to conduct transaction with User 5, the seller can utilize the option of declining an offer. The seller will click on the “decline now” link next to User 5, in bold print. The system controller will then inquire if the seller wants to decline the offer made by User 5 at $255. If the seller replies “yes”, then the system controller will request an explanation for such action. Once the seller enters the reason for the decline, system controller will invalidate the offer of $255 and block User 5 from this auction. Concurrently, the system controller will notify such change to User 5 via email with a copy of seller's explanation attached.

After this change, system controller will re-display all offers on the item to the seller, which will look like the following:

| | | |
|---|---|---|
| $235 | User 2 (Feedback History) | Decline Now |
| $177 | User 3 (Feedback History) | Decline Now |
| $146 | User 6 (Feedback History) | Decline Now |
| $132 | User 1 (Feedback History) | Decline Now |
| $88 | User 4 (Feedback History) | Decline Now |

The seller can decline more than one offer on each auction. If the seller chooses to decline another offer, the operational process repeats itself.

FIG. 6 is a detail diagram of the operational process of the “accept an offer” function granted to a seller in a Buyer's Offer auction. The process begins when a seller chooses the “accept an offer now” function on the auction listing web page. For instance, the seller in the example of “carved ivory cameo” clicks on the “accept an offer now” button in FIG. 2 where carved ivory cameo is listed.

For security purpose, the system controller will request the particular seller to enter the seller's User ID and password with the online network. If the seller's User ID or password does not match the record maintained by the system controller, access to accepting an offer function will be denied. The system controller will re-request the seller's User ID and password until both match the record maintained by the system controller. It is optional for the system controller to set a maximum trial time for such request for advanced site security.

If the seller's User ID and password match the record maintained by the system controller, a list of all offers placed on the carved ivory cameo will be displayed to the seller. The list will be sorted by price from the highest to the lowest. The list will contain each offer, each User ID and its associated feedback history. There will also be an accept now function linked with each offer placed on the item. For illustration:

| | | |
|---|---|---|
| $255 | User 5 (Feedback History) | Accept Now |
| $235 | User 2 (Feedback History) | Accept Now |
| $177 | User 3 (Feedback History) | Accept Now |
| $146 | User 6 (Feedback History) | Accept Now |
| $132 | User 1 (Feedback History) | Accept Now |
| $88 | User 4 (Feedback History) | Accept Now |

As in the example, User 5 has the highest offer on the carved ivory cameo for $255. If the seller is satisfied with the offer of $255 and wants to have immediate liquidity, the seller can exercise the option of accepting an offer.

The seller will click on the “accept now” link next to User 5, in bold print. The system controller will then inquire if the seller wants to accept the offer made by User 5 at $255. If the seller replies “yes”, then the system controller will end the auction instantly. The system controller will record $255 as the winning offer and User 5 as the winner of the carved ivory cameo. The system controller will then display User 5's name and address record to the seller so that the seller can send an invoice to User 5 requesting payment for the item.

Concurrently, the system controller will notify the all participating buyers of the outcome of the auction including the winning offer and the winner's User ID.

The web page associated with this auction will be available to all users in the network and will look like the following as illustrated in FIG. 2:

Categories: Jewelry > Antique Jewelry > Fine > Cameo > Ivory
Carved Ivory Cameo #1234567890

| | |
|---|---|
| Start Date: | 09-01-2003 18:30 |
| End Date: | 09-08-2003 18:30 |
| # of Offers: | 6 |
| Winning Offer: | $255 |
| Winner: | User ID 5 |

Detailed Description of the Cameo
Pictures

It is noted that the above figure merely illustrates the fields that are relevant to a preferred embodiment of the invention. Such figure is not meant to illustrate the actual layout of a web page after the auction closing. An actual web page would be laid out in a creative, artistic fashion so as to present a pleasing visual appearance.

FIG. 7 is a detailed diagram of the operational process of “make an offer” function given to all potential buyers and “retract an offer” function granted to all participating buyers. The process begins when a potential buyer is ready to use the “make an offer now” function on the auction listing web page. For instance, the seller in the example of “carved ivory cameo” clicks on the “make an offer now” button in FIG. 2 where carved ivory cameo is listed.

For security purpose, the system controller will request each buyer to enter the buyer's User ID and password with theonline network. If a buyer's User ID or password does not match the record maintained by the system controller, access to make an offer function will be denied. The system controller will re-request the buyer's User ID and password until both match the record maintained by the system controller. It is optional for the system controller to set a maximum trial time for such request for advanced site security.

When the buyer's identity has been confirmed by the system controller, the system controller will inquire about and confirm the offer this buyer would like to make. Once an offer has been confirmed, the system controller will display to all network users all sealed offers on the carved ivory cameo. These sealed offers are sorted by time of entry, from the oldest to the newest, for instance. The web page for displaying these sealed offers will look like the following:

| | | | |
|---|---|---|---|
| User 6 | 9:15 | 09-01-2003 | Retract Now |
| User 4 | 10:45 | 09-01-2003 | Retract Now |
| User 2 | 13:01 | 09-03-2003 | Retract Now |
| User 5 | 18:11 | 09-03-2003 | Retract Now |
| User 1 | 8:22 | 09-04-2003 | Retract Now |
| User 3 | 12:55 | 09-05-2003 | Retract Now |

“Retract an offer” option is granted to only the participating buyers in the auction. For example, after User 1 has placed an offer on the carved ivory cameo, it decides not to participate in the auction for some reason. User 1 can exercise the option of retracting an offer. User 1 will click on the “retract now” link next to User 1's offer entry time, in bold print.

For security purpose, the system controller will request User 1 to enter its User ID and password with the online network. If a User 1's User ID and password do not match the record maintained by the system controller, access to retract an offer function will be denied. The system controller will re-request the User 1's User ID and password until both match the record maintained by the system controller. It is optional for the system controller to set a maximum trial time for such request for advanced site security.

Once User 1's identity is confirmed, the system controller will then inquire if User 1 wants to retract the offer of $132. If User 1 replies “yes”, then the system controller will request an explanation for such action. Once User 1 enters the reason for the retraction, system controller will invalidate the offer of $132 and block User 1 from this auction. Concurrently, the system controller will notify such change to the seller via email with a copy of User 1's explanation attached.

After this change, system controller will re-display all sealed offers on the item to all users, which will look like the following:

| | | | |
|---|---|---|---|
| User 6 | 9:15 | 09-01-2003 | Retract Now |
| User 4 | 10:45 | 09-01-2003 | Retract Now |
| User 2 | 13:01 | 09-03-2003 | Retract Now |
| User 5 | 18:11 | 09-03-2003 | Retract Now |
| User 3 | 12:55 | 09-05-2003 | Retract Now |

In the case when two or more bidders enter the same highest offer for the same item in a Buyer's Offer auction, the one who first places the highest offer will be declared the winner by the system controller if the seller forgoes the option to accept a winning offer prior to the auction end date. For example as scenario described earlier:

| | | | |
|---|---|---|---|
| $255 | User 5 | 18:11 | 09-03-2003 |
| $255 | User 2 | 13:01 | 09-03-2003 |
| $255 | User 3 | 12:55 | 09-05-2003 |
| $146 | User 6 | 9:15 | 09-01-2003 |
| $132 | User 1 | 8:22 | 09-04-2003 |
| $88 | User 4 | 10:45 | 09-01-2003 |

Since User 5, User 2, and User 3 Entered the same highest offer of $255, the winner at the auction end date would be determined by the offers' entry time. Since User 2 was the first one who made the offer at $255 (see time of entry in bold print), User 2 would be declared the winner of this Buyer's Offer auction by the system controller.

As described above in detail, the present invention provides us with a superior archetype for conducting online auctions for good and services, rights or properties.

In a Buyer's Offer auction, all offers are sealed from other users within the network. This in turn diminishes sellers' inventive to engage in shill bidding, which is the most commonly used method to inflate price of an auction result in a no reserve format. Similarly, since no buyers are aware of the offers made by others, the competitive tension built among all participating buyers is reduced to minimum, thus lessen the probability of generating an over-priced result in a bidding war.

In a Buyer's Offer auction, each buyer is only allowed to make one single offer during the course of the auction listing. Hence buyers are no longer induced to employ last minute bidding strategy, which often results in under-priced items for sellers.

In a Buyer's Offer auction, there is no reserve price for the auction item. Sellers are not the ones who dictate the value of the item; accordingly, participating buyers can make offers that are best in their judgments, and the winner of such auction is guaranteed to acquire the item regardless seller's price preference, in contrast to name-your-price auctions. It is important to understand that the current invention is not merely a new format for conducting online auctions; rather it is designed to promote discovery of fair market price through full utilizations of buyers' knowledge about an item.

Moreover, unlike a buy it now auction where either lack of knowledge by the seller or the buyers can result in under-priced or over-priced auction result, a Buyer's offer auction eliminates the first mover advantage, removes the instant buying pressure, and replaces them with the opportunity for thoughtful considerations by both the seller and the buyers.

Since all offers are sealed from other buyers and sorted by time of entry, potential buyers are not informed of others' assessments about the item. It is reasonable to expect there are differences among buyers' knowledge; however, buyers will not have the objectives to conceal their knowledge at all in such an auction. In view of the fact that only the first-placed highest offer will be the winning offer, buyers are inclined to place their best offers in an attempt to acquire the item. For a buyer with superior knowledge of the item, he/she will have no interest to make an inferior offer to the seller because he/she is only given one chance for obtaining the item. Likewise, a buyer with inferior knowledge of the item will not have the incentive to make an overestimated offer while being mislead by others'bids.

Sellers in online auctions are well aware of the effect of “heard behavior”, which provokes a need for sellers to place multiple bids in order to attract potential buyers. In a Buyer's Offer auction, each user is entitled to only one offer; this restriction decreases the likelihood of a seller exploiting naive buyers through the creation of a large offer pool. Single offer method also reduces the sunk costs buyers devote into an online auction. Consequently, such reduction in sunk costs also reduces the likelihood of an over priced auction result.

Besides the advancements made to the existing auction methods, a Buyer's Offer auction still preserves the beauty of instant liquidity, which is considered significant to many online sellers. Sellers can achieve inuediate liquidity through an offer acceptance prior to auction end date.

In summary, the present invention has demonstrated its superiorities over other online auction formats in terms of improved price discovery mechanism, enhanced fraud reduction mechanism, and preservation of instant liquidity.

It should be understood that while various embodiments of the invention have been described, those skilled in art could make various changes in form, detail, and design without departing from the principle, spirit, and scope of the invention described herein. Applicant's invention is limited only by the scope of the appended claims.

1. A method of conducting a sealed offer auction, the method comprising: a) receiving one sealed offer from each bidder; b) all offers are kept sealed from other bidders, but are open to only the seller of the item; c) all offers are arranged in an order according to the time when the offers are placed; d) the auction has a scheduled deadline provided by the auction system provider and selected by the seller of the item; e) the seller has the option to end the auction anytime prior to the auction deadline by accepting one single offer from the offering pool; f) the seller has the option to disqualify any bidder prior to the auction deadline by the method of declining an offer; g) the seller is obligated to accept the highest offer at the auction deadline; h) the winner of the auction prior to the auction deadline is chosen by the seller; i) the winner of the auction at the auction deadline is chosen by the auction system controller based on the first-placed highest offer on that auction; j) bidders can retract their a offers prior to auction end, but the retractors will be automatically disqualified by the auction system controller for placing any future offers on that auction.

2. A method as in claim 1 wherein said auction is an online auction.

3. A method as in claim 1 wherein said auction is for goods and services.

4. A method as in claim 1 wherein said auction is for rights or properties.

5. “Auction System Provider” in claim 1 is an online auction service provider or an online auction host.

6. An online system for conducting a seal offer auction, the system comprising:
a) A controller;
b) Seller's terminal which communicate with said controller whereby seller can enter and transmit, prior to the beginning of an auction, a listing for said at least one item, a listing comprising the headline, the detailed description of the item, pictures associated with the item, shipping and payment terms, and the auction duration;
c) Web pages which display said auction listing;
d) A plurality of individual buyer terminals which communicate with said controller whereby said plurality of individual buyers can make or retract to said computer server a single offer for the auctioning item prior to the auction end;
e) Said controller displaying the offers on the item from the highest to the lowest to said seller only;
f) Said controller displaying said plurality of individual buyers' user IDs on the item according to time of entry to all users;
g) Said seller can communicate with said controller through seller's terminal whereby said seller can either accept or decline any offer from said plurality of individual buyers;
h) A winner of said auction listing whose offer is accepted by said seller prior to auction end date, or whose offer is the first-placed highest according to said system controller at the auction end date;
i) A system time tracker which operates on said computer server to track offers placed by said plurality of individual buyers according to time of entry of said offers;
j) An email system which operates on said computer server to notify said seller and said plurality of individual buyers any offer acceptance, offer decline, and offer retraction related to said auction listing; and the said email system allows communications between said seller and said plurality of individual buyers regarding said auction listing;
k) A database system which operates on said computer server to store information or data such as user IDs, passwords, email addresses, contact information, credit card numbers, banking account numbers, feedback histories, and all information related to auction listing, processing, and ending results;
l) A check out system which operates on said computer server to allow said seller enter and calculate total transaction amount and deliver said seller's contact information via email to said winner; and the said check out system is programmed to display said winner's contact information to said seller upon auction closing.

7. The system recited in claim 4 operating in accordance with said specified and limited time period whereby offers for a particular item are only accepted for said specified and limited time period.

8. The system recited in claim 4 wherein said seller terminal is terminal connected to the Internet.

9. The system recited in claim 4 wherein said plurality of individual buyers terminals are terminals connected to the Internet.

10. The system recited in claim 4 wherein said controller comprises a server.

11. The system recited in claim 4 wherein said seller terminal and said plurality of individual potential buyer terminals communicate with said controller via the Internet.
